(19) United States
(12) Patent Application Publication
(10) Pub. No.: US 2019/0254244 A1
(43) Pub. Date: Aug. 22, 2019

(54) SUSTAINABLE AND SCALABLE INDOOR AND OUTDOOR FARMING

(71) Applicant: Revolution Agriculture, Inc., Rio Rancho, NM (US)

(72) Inventor: Richard Doyle BRION, Tacoma, WA (US)

(21) Appl. No.: 16/348,272

(22) PCT Filed: Nov. 8, 2017
(86) PCT No.: PCT/US2017/060693

§ 371 Date: May 8, 2019

Related U.S. Application Data
(60) Provisional application No. 62/419,265, filed on Nov. 8, 2016.

(51) Int. Cl. A01G 31/02; A01K 63/04

(52) U.S. Cl. CPC A01G 31/02; A01G 2031/006; A01K 63/04

(57) ABSTRACT

Methods and systems for commercial, sustainable and scalable indoor & outdoor farming can use aquaponics integrated with apiculture and breeding of Lepidoptera for pollination, renewable energy and heating sources, hybrid aquaculture and growing beds, vertical growing towers, specialized shipping container modules, and an optimal farm planning tool that can be placed in any environment and climate, in rural or urban areas and begin producing food and other crops within a few weeks.

### CROSS-REFERENCES TO RELATED APPLICATIONS

The present application claims the benefit of U.S. Provisional Application No. 62/419,265 entitled, “Method for Commercial, Sustainable and Scalable Indoor & Outdoor Farming,” filed Nov. 8, 2016, the full disclosure of which is incorporated herein by reference in its entirety for all purposes.

### BACKGROUND

The present invention is in the technical field of growing food, grasses and other textile crops in a more sustainable and scalable manner (also known as “agriculture”). More particularly, the present invention is in the technical field of Aquaponics.

Aquaponics generally uses separate aquaculture tanks and growing tanks in an indoor setting. Growing indoors creates a scenario where it requires 82±11 times the energy use of traditional farming per acre, increasing the costs of goods sold. Further, aquaponics is limited in crop selection due to indoor growing restrictions that prevent pollination and an inability to maintain the closed system. Moreover, commercial viability suffers from inefficiencies within the planning and operations of aquaponics farms.

### BRIEF SUMMARY OF THE DISCLOSURE

In one embodiment, the present disclosure relates to a modular aquaponics/hydroponics system that cycles water through contained aquaculture and agriculture modules. Various embodiments include further energy recycling means to enhance yield. For example, in some embodiments, systems described herein use renewable energy sources prevalent in the area of each farm to eliminate energy purchase requirements. Energy sources used include solar power, geothermal power, wind power, hot spring water used for induction heating and solar water heaters. Some embodiments include a method to incorporate apiculture and commercial breeding of Lepidoptera into the aquaponic system. At least one embodiment also incorporates vertical towers to allow growing of crops vertically within the space. Some embodiments can include a trough that is installed into the ground and then filled with a soil bed. This trough is sloped to a collection point, where the water is collected and filtered before being pumped back into the aquaculture tanks. This feature creates the ability for aquaponics to be used in outdoor farming. Further, the above embodiment can be used indoors, to allow growing of crops using soil indoors in aquaponic and hydroponic systems. Additionally, embodiments described herein include single tank hybrids of the aquaculture tank and hydroponic growing beds for indoor farming, where the crops grow on top of the fish, reducing the extent of required piping and energy costs associated with pumps.

In another embodiment, modular aquaponics/hydroponics system can be integrated with a modeling tool that determines the optimal crop and fish production based on multiple constraints to maximize the profit per square foot of the farm, rendering it more profitable and commercially viable. Such systems can be integrated with monitoring sensors to detect changes in the aquaponics/hydroponics system and adjust parameters of the system to maintain optimal yields. Lastly, at least one embodiment includes an integrated, turn-key aquaponics farm delivered in an ISO shipping container or containers that allow for rapid setup and deployment of farms to rural and/or remote areas.

Embodiments of a modular aquaponics/hydroponics system as described herein can analyze the performance and needs of an individual farm and incorporates one or more of these modules to meet the goals of the individual user, while accounting for unique environmental and other considerations to create the optimal farm. Modules can be added to any user farm at any point in the future as needed to improve farm yield, making the farm modular, scalable, and able to be tailored to a user's preferences.

### BRIEF DESCRIPTION OF THE DRAWINGS

The present disclosure will be better understood in view of the appended non-limiting figures.

FIG. 1 is a perspective view of the integrated Apiculture hives within the closed, indoor system of the present invention;

FIG. 2 is a side view of the hybrid aquaculture/hydroponic tanks of the present invention;

FIG. 3 is a top view of the specialized trough and drainage system of the present invention

FIG. 4 is a side view of the hot springs induction water heating of the present invention.

FIG. 5 is a side view of the solar water heating incorporation of the present invention.

FIG. 6 is a plan view of the Optimal Farm Planning Tool produced by the present invention.

FIG. 7 is a flow-diagram of steps of a method of the present invention.

FIG. 8 is a perspective view of the vertical growing towers of the present invention.

FIG. 9 is a perspective view of the specialized ISO shipping containers of the present invention.

FIG. 10 is a perspective view of the incorporation of indoor breeding of Lepidoptera of the present invention.

While the following is amenable to various modifications and alternative forms, specific embodiments have been shown by way of example in the drawings and are described in detail below. The intention, however, is not to limit the claims to the particular embodiments described. On the contrary, the description is intended to cover all modifications, equivalents, and alternatives thereof.

### DETAILED DESCRIPTION OF THE INVENTION

Various embodiments disclosed herein relate generally to a modular aquaponics system for commercial, sustainable and scalable farming. Embodiments described herein include combined hydroponics and aquaculture systems that cycle water through an aquaculture system, where the water entrains nutrient-rich aquaculture effluent, and through a hydroponics system where the water is depleted of the fish-effluent nutrients and provides water for crop growth. Unlike known aquaponic systems, the hydroponics wastewater is cleaned of excess plant nutrients (e.g., phosphates, nitrates, and the like) leached from the crop substrate or soil before being routed back to supplement the water source for aquaculture. Various embodiments relate to further methods and systems for using renewable energy sources to control water temperature, for reducing the energy requirements of the aquaponics system, and for providing a self-contained growth environment for sustainable farming.

The disclosure may be better understood with reference to the Figures, in which like parts have like numbering.

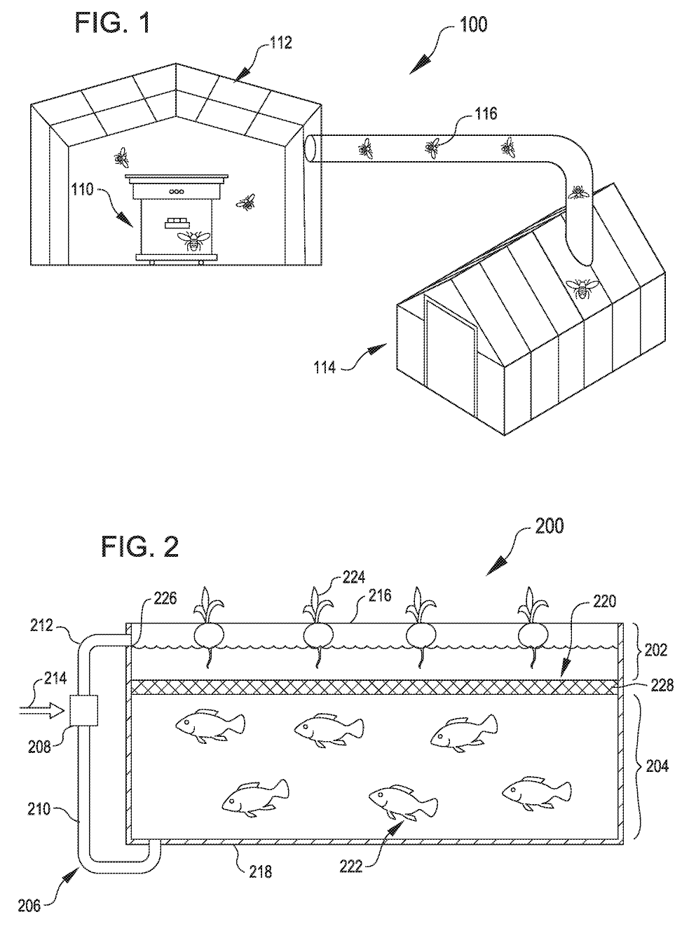

FIG. 1 shows a combined apiculture/greenhouse system 100 including an apiculture hive 110 that is housed in a separate apiculture module 112 and connected to an indoor greenhouse module 114 by closed ducting 116. This arrangement allows bees to travel between their hive 110 and the greenhouse module 14 and pollinate plants and crops that cannot traditionally be grown in indoor greenhouses or in typical aquaponic and hydroponic systems. Honey collected from the hive 110 can be sold as a revenue stream.

FIG. 2 shows a first example of an aquaponics system 200 that includes a hybrid aquaculture/hydroponic tank 218 divided into a hydroponics portion 202 and an aquaculture portion 204 by a tank divider 220, in accordance with various embodiments of the present disclosure. The tank divider 220 keeps the fish 222 from accessing, eating and destroying the root systems of the crops 224. This tank divider 220 allows tank water 226 to pass, but not the fish 222. In operation, crops 224 clean the water 226 without having to leave the tank and be pumped through pipes to separate growing media when used indoors.

The aquaponics system 200 can further include a recirculation system 206 for reintroducing nutrient-rich aquaculture effluent from the aquaculture portion 204 to the hydroponics portion 202. For example, a pump 208 can drive fluid flow from an effluent outlet pipe 210 to a hydroponics inlet pipe 212 in order to draw the nutrient-rich wastewater back to the crops 224. In some embodiments, the amount of wastewater returned can be moderated by mixing wastewater with a source of fresh water 214. The source of fresh water 214 may be pre-treated with any suitable nutrients or diluents for improving the suitability of the water stream for hydroponics, e.g. for adjusting a pH, nutrient content, or the like.

The crops 224 can be planted in a substrate 216 for positioning and maintaining an appropriate crop level in the hydroponics portion 202. In some cases, the substrate 216 can be a thin support that holds the crops 224 above, or in contact with, the water 226 of the hydroponics portion 202. In some embodiments, the substrate 216 can be, or can include, soil or another growth or support medium extending as far as the tank divider 220.

In some embodiments, the tank divider 220 includes a filtration medium 228 for preventing the ingress of plant debris, soil, growth medium, or support debris from the hydroponics portion 202 to the aquaculture portion 204 of the aquaponics system 200. The filtration medium can also, or alternatively, include a filtration element for removing excess plant nutrients from the water 226 as the water passes into the aquaculture portion. For example, in some embodiments the filtration medium can include one or more, or any suitable combination of: a porous activated carbon, biochar, lava rock, sand, gravel, perlite, clay pebbles (e.g., light expanded clay aggregate or similar), woven or nonwoven textile filters, or other comparable filtration material. In some embodiments, the filtration element also provides for pH adjustment of water exiting the hydroponics portion 202 to improve suitability of the water for fish 222.

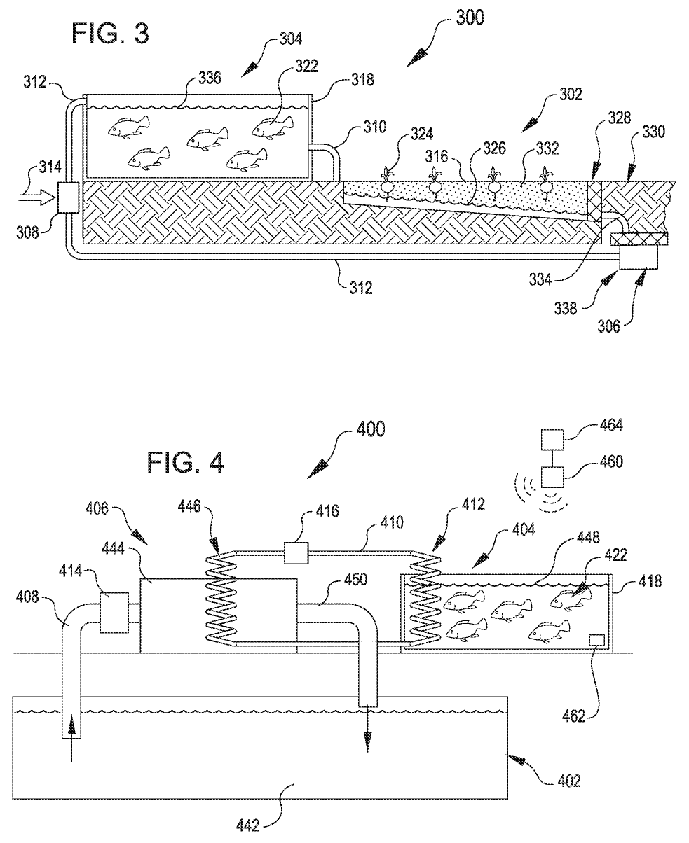

FIG. 2 showed an integrated aquaponics system in a stacked configuration. However, in other embodiments of the present disclosure, aquaculture and hydroponics modules can be laid out in varying arrangements with a circulating water system. For example, FIG. 3 shows an example of an aquaponics system 300 that includes an upstream aquaculture module 304 that feeds a downstream hydroponics module 302. In the aquaponics system 300, a specialized bed 328 is shown placed below ground level 330. Soil and/or plant growing media 332 is then placed into the specialized bed 328. The specialized bed 328 is sloped to a water collection drain 334. Fish aquaculture effluent 336 from the aquaculture module 304 is routed into the specialized bed 328, e.g. via an outlet pipe 310 from the aquaculture tank 318, to provide water 326 to the soil or growing media 332.

In operation, the crop 324 cleans the aquaculture effluent 336, and clean effluent drains from the bed 328 into the drain 334, where it is pumped into a filtration module 306 that removes any remaining soil or debris from the cleaned effluent before it is pumped back into the aquaculture tanks 318. This allows aquaponics to be used in outdoor growing conditions for crops 324 like bamboo, coffee, grapes, grasses and any other desired outdoor crop 324. The filtration module 306 can include a filtration element 338 with filter media for removing excess plant nutrients. For example, in some embodiments the filtration medium can include one or more, or any suitable combination of: a porous activated carbon, biochar, lava rock, sand, gravel, perlite, clay pebbles (e.g., light expanded clay aggregate or similar), woven or nonwoven textile filters, or other comparable filtration material. The water 326, after cleaning by the crops 324 and/or filtration module 306, can be pumped back to the aquaculture module 304 via an inlet pipe 312 and inlet pump 308. In some embodiments, a source of fresh water 314 can be added to the system 300 at the aquaculture module 304 or pump 308 to account for gradual water absorption or evaporation.

Embodiments of the aquaponic systems described herein can be combined with renewable energy capture or exchange to further reduce system energy costs. For example, FIG. 4 shows an example of an aquaponic system 400 utilizing an environmental (i.e. ground) water reservoir 402 to control water temperature in an aquaculture module 404, in accordance with various embodiments of the present disclosure. In one embodiment, the environmental water reservoir 402 is a geothermal water source, i.e. a hot spring, and can be used to increase the temperature of the water in the aquaculture module 404. However, it will be understood that any groundwater source, flowing water source, lake water source, or other water source can be used for the benefit of its relatively stable temperature. For example, in some embodiments, the water reservoir 402 can be a cool groundwater source or flowing water source, and can be used to prevent over and under heating in the aquaculture module 404.

FIG. 4 shows environmental water 442 from the environmental water source 402 being pumped via an inlet pipe 408 and pump 414 into a heat exchange module 406. The heat exchange module 406 includes a heat exchange enclosure or basin 444. Inside the enclosure 444 a heat exchange element 446 in the form of heat-conductive coiled tubing (i.e., copper tubing or similar) provides a high surface area for heat transfer between environmental water in the enclosure 444 and an enclosed working fluid, e.g. water, within the heat exchange element 446.

In some embodiments, the heat exchange element 446 can pass water 448 directly from the aquaculture module 404, which can be forced via a pump 416 and heat exchange piping 410, or can be naturally forced via convective action. In alternative embodiments, the heat exchange element 446 can be part of a closed loop including a second heat exchange element 412 within the aquaculture tank 418 of the aquaculture module 404.

In embodiments using direct heat exchange, water 448 from the aquaculture tanks 418 is routed through the coiled tubing 446 into the basin 444 where the environmental water 442 heats or cools the aquaculture water 448 in the coiled tubing. The heated aquaculture water 448 is then routed, either actively or passively, back into the aquaculture tanks 18. The use of environmental heating or cooling via the environmental water reservoir 402 keeps the aquaculture water 448 in the system 400 at a consistent temperature without the use of traditionally powered heating or cooling elements. The enclosure 444 contains an overflow channel 450 that can drain environmental water 442 back to the environmental water source 402, thus only borrowing the water rather than consuming it.

In some embodiments, the aquaponics system 400 can include a controller 460 and sensing elements 462 for detecting the temperature of the aquaponics water 448 and adjusting the operational parameters of the system to maintain the appropriate temperature at the aquaculture module 404. For example, in some embodiments, the controller 460 can respond to a temperature reading at the sensors 462 by comparing the detected temperature to an approved range or threshold, and can modify the flow rate of water through the heat exchange element 446 accordingly. For example, if the aquaponics system 400 is using a hot spring for heating the aquaculture module 404, the controller 460 can respond to a high temperature warning by decreasing the rate of heat exchange, or to a low temperature warning by increasing the rate of heat exchange. Conversely, if the aquaponics system 400 is using a cool water reservoir for cooling the aquaculture module 404, the controller can respond to a high temperature warning by increasing the rate of heat exchange, or to a low temperature warning by decreasing the rate of heat exchange. Thus, depending on the local environment (i.e., hot and arid, temperate, or cold), aquaponic systems can be developed to use hot or cold water reservoirs as a substitute for direct heating or cooling. The parameters and thresholds for heating and cooling the system can be controlled by way of a user interface module 464.

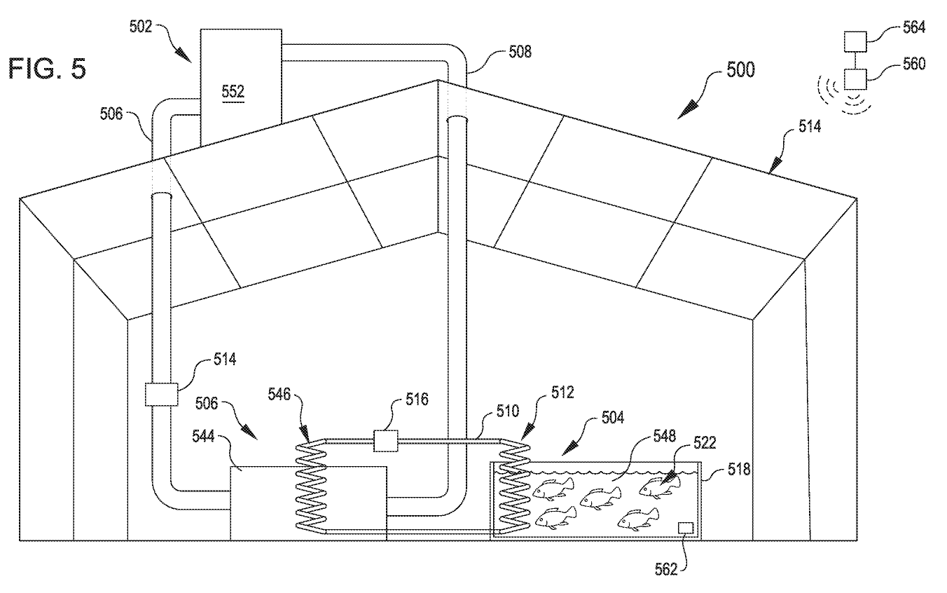

FIG. 5 shows another example of an aquaponic system 500 using a solar heating module 502 including a solar water heater 552 placed on the top of a greenhouse 514 where water is heated by the sun and then sent through pipes 550 into a heat exchange module 506. The heat exchange module 506 includes an enclosure or basin 544 containing a heat exchange coil 546. As noted above with respect to the embodiment of FIG. 4, the water 548 from the aquaculture module 404 (i.e. from aquaculture tanks 418) circulates through the heat exchange tubing 510 to the heat exchange coil 546 in the enclosure 544, where the water in the basin 544 transfers heat. The aquaculture water 548 then returns to the aquaculture tanks 418 at an elevated temperature for regulating the temperature in the aquaponics system 500. Aquaculture water 548 can be circulated via natural convection or can be forced, e.g. by way of a pump 516 along the heat exchange tubing 510. In alternative embodiments, the exchange tubing 510 can include a second heat exchanger 512 in a closed system that transfers heat between the heat exchange module 506 and the aquaculture tanks 418.

Water in the enclosure 544 is recycled to the solar water heater 552, e.g. via a return pipe 550 and pump 514, reusing the water. As described above with reference to the aquaponics system 400 of FIG. 4, the aquaponics system 500 can include a controller 560, sensing elements 562, and/or user input module 564 for controlling the operation of the system. In various embodiments, the sensing elements 562 can be used for detecting the temperature of the aquaponics water 548 and adjusting the operational parameters of the system 500, e.g. increasing or decreasing flow rates through the heat exchange coil 546, to maintain the appropriate temperature at the aquaculture module 504.

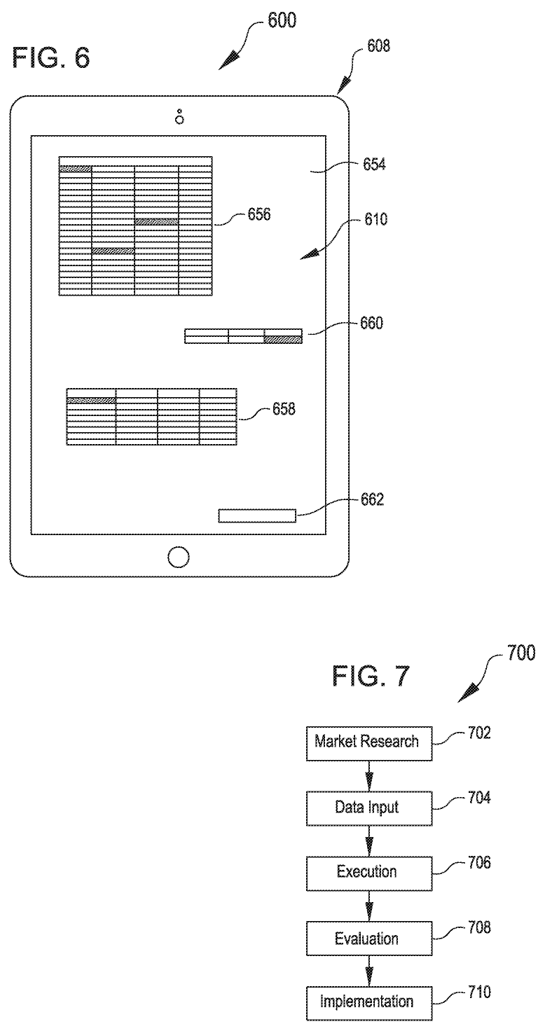

FIG. 6 illustrates an optimization system 600 for viewing and modifying system parameters of any of the aquaponic systems described herein. The optimization system 600 includes a user input and output device 608 including an interface 610 which can be implemented on any suitable computing device, tablet, smartphone, or other device. Suitable devices may include entirely self-contained processing, or may connect with a remote or cloud service. The interface displays a software display 654 on which is displayed a plurality of decision constraints 656, a plurality of production options 658 and a maximization of revenue or profit function 660. The decision constraints 656 include a range of environmental factors, crop limitations and space considerations that constrain growing ability of the system. These decision constraints 656 are expressed as formulae.

Using an application programming interface, the software pulls current wholesale pricing data for specific markets. The software then updates the formula automatically using this pricing data for each crop and fish option selected to create a maximization formula. By way of example, the software would then maximize X(A)+X(B)+X(C), where X is the number of units of the optimal solution, and A, B, and C represents the current or expected market price per unit of the specified crop or fish. The number of units can be expressed in terms of a predefine block of growing space or modules of a particular size, e.g., directly in terms of square feet or meters of growing space. The software then limits the optimized solution to the bounds of the specified constraints.

As another example, for a system with a limited number of hydroponics units, if A represents a market price of strawberries, and B is tomatoes, the software sets the constraint that if A is present, B cannot be used because strawberries and tomatoes cannot be grown in the same unit. Another constraint can be set based number of plants per unit area. For example, if a client farm uses growing beds totaling 185 square meters (2,000 square feet), the constraint equation would follow the pattern of X(A)+X(B)+X(C) . . . ≤185. This prevents the software from maximizing revenue by selecting more of each crop than can grow in the given bed. The software can process an arbitrarily large number of constraint variables that are unique to the individual client farm setup, as well as the data collected from the systems. As an example, if the software is initially programmed where lettuce can only experience 10 harvests in a year, the constraint to lettuce would be X(A)≤10; however, should the data collected by the system indicate that lettuce can be turned 11 times in a year, the software then automatically adjusts this constraint.

According to another example, production options 658 include selling price of each crop or fish and other productivity factors, such as but not including a rate of crop turnover, e.g. a number of turnovers in a 12-month period. The production options 658 are expressed in terms of units, currency or other integer and non-integer numbers related to the specific production option 658 of the crop or fish. A user may input any suitable decision constraints 656 and production options 658 into the software display 654, which can return a crop and fish selection using the maximize profit/revenue function 660 corresponding to a maximum revenue for the specific farm configuration as defined by the decision constraints 656. Examples of decision constraints include, but are not limited to: minimum plant spacing, conflicting crops that cannot be planted together, growing media and/or beds selected, etc. This selection tells the user what crops and fish to grow in order to maximize the profit or revenue of the farm given the input constraints. The calculations are largely unseen by the user, as the graphical user interface provides easy, interactive options that set the decision parameters without the user having to manually setup the formulae.

FIG. 7 illustrates an example process 700 associated with the optimization system 600 described above with reference to FIG. 6. In at least one embodiment, the method 700 begins with a market research step (act 702) where the system receives user collected data and/or stored data concerning environmental and markets factors (i.e. current market prices of available plant crop and aquaculture fish crops), the present configuration of the modular elements of the farm (i.e., numbers of apiculture, aquaculture, and hydroponic modules, and productivity estimates thereof), and optionally including various decision constraints and production options as specified by the user. A data input step (act 704) includes receiving an input, e.g. a user input via the software display 654, defining the decision constraints 656 and production options 658 as described above with reference to FIG. 6. The optimization process can then be executed (act 706), wherein the system performs an optimization calculation to select a fish crop or crops and a plant crop or crops that maximizes revenue by the system. The estimated revenue/profit should be translated into a user-viewable form and presented for display, e.g. at a user input/output device like the device 602 of FIG. 6. The system can then perform an evaluation step (act 708) in which the system generates a prompt for a user to retain the presented solution, or to change a parameter and repeat the data input and executions steps above. The system can iteratively allow for a user to repeat these steps as many times as desired with varying decision constraints and production options to allow for comparison of revenue outputs given the varied constraints. In the implementation step (act 710), the system prompts the user to select a set of design constraints and production options that best suits their goals and outputs a summary of the selected constraints and options corresponding to the configuration, requisite crops, and fish for placing into the system.

The systems and methods disclosed herein for implementing the aquaponic systems described above relate generally to recycled water systems that move water between one aquaculture module and one hydroponics module, potentially in combination with greenhouse containment, apiculture, and renewable heating or cooling. However, it will be understood that further embodiments can employ multiple and potentially many aquaculture modules and hydroponics modules. These modules can be arranged in pairs, or can be distributed in ratios other than 1:1, e.g. with multiple hydroponics modules connected with each aquaculture module, or vice versa. In addition, alternative forms of hydroponics or aquaculture modules may be used to improve efficiency.

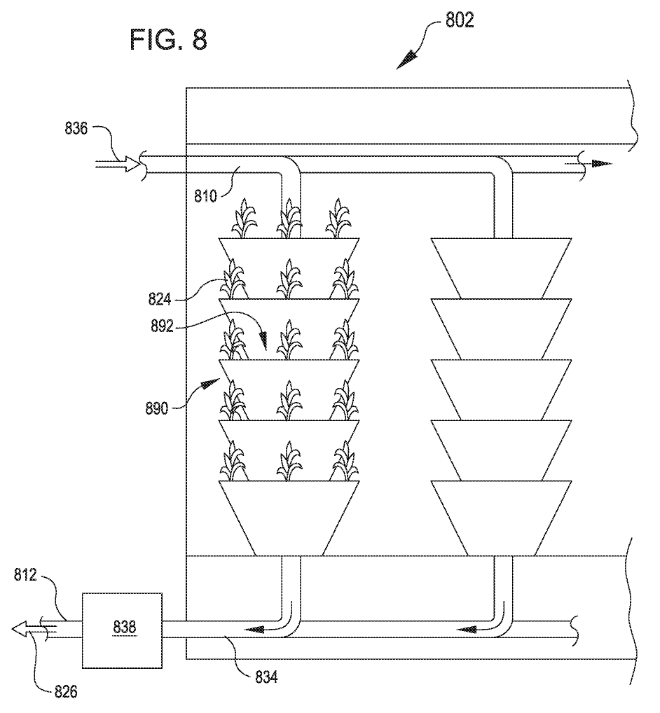

For example, FIG. 8, shows an example of a vertical growth system 800 that includes multiple vertical growing tower 890 in a greenhouse environment 814. Each vertical growing tower 809 can pass water down through several layered growing beds 892 in series, each layer containing crops 824. The growing towers 890 can receive water from aquaculture tanks (not shown) via piping 810 driven by pumps. As in the traditional system, the fish effluent 836 is pumped to the crops 824 in the layered growing beds 892. These growing towers 890 allow crops to be grown within the vertical space of a greenhouse 814 and occupying less space than conventional planting. In accordance with one embodiment, the vertical growing towers 890 are cylindrical towers with heights ranging from 2 feet to 10 feet in height and having a plurality of diameters. Additionally, each vertical tower 890 has an angled opening at the 892 contained at defined intervals to allow for plants to grow directly from the vertical towers 890. Each vertical tower 890 is used to grow crops 824 and also to filter the water containing fish effluent 836. Water supplied to the vertical towers 890 can be removed from the greenhouse 814 by way of an outlet 834 and passed through a filtration element 838 similar to the filtration element 338 (FIG. 3) that removes debris and also conditions the wastewater by removing excess plant nutrients (e.g., excess nitrates, phosphates, or the like) before the filtered wastewater 826 is removed from the greenhouse 814 by an outlet 826 for use in aquaculture and ultimately recycled.

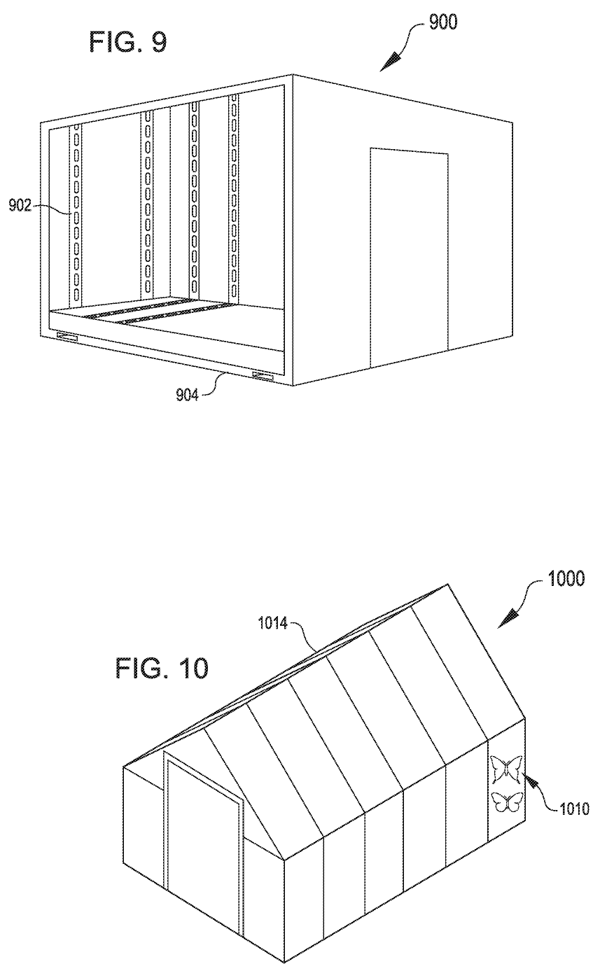

Embodiments of the modules described above can be implemented in discrete units for ease of transport and modular installation. For example, FIG. 9 shows a specialized ISO shipping containers 900 for containing an aquaculture, hydroponic, or apiculture module as described above, in accordance with at least one embodiment of the present disclosure. These containers 900 can be equipped with various wall and floor fasteners 902 designed to hold system components specific to the module and specific to the designed farm, and that are necessary to build the scaled present invention at any site delivered. The specialized shipping containers 900 can be equipped with Pallet Loading System (PLS) rollers 904 on the bottom to allow easy shipment for private, commercial, or even for military transport.

Greenhouse-contained hydroponic modules as described above can be combined productively with various pollinating insects, including Lepidoptera, among others, Referring now to FIG. 10, an aquaponic system 1000 can include an indoor greenhouse 1014 (and other modules, not shown) for growing crops. In that indoor greenhouse 1014, a portion can be used as a breeding area 1010 for Lepidoptera or other pollinating insects. The Lepidoptera can live in the indoor greenhouse 1014 and pollinate the crops selected to live in the system 1000.

While the foregoing written description of the invention enables one of ordinary skill to make and use what is considered presently to be the best mode thereof, those of ordinary skill will understand and appreciate the existence of variations, combination and equivalents of the specific embodiment, method, and examples herein. The invention should therefore not be limited by the above embodiment, method and examples, but by all embodiments and methods within the scope and spirit of the invention as claimed.

In the preceding description, for the purposes of explanation, numerous details have been set forth in order to provide an understanding of various embodiments of the present disclosure. It will be apparent to one skilled in the art, however, that certain embodiments may be practiced without some of these details, or with additional details. Further, specific materials and material properties as described with reference to one embodiment (e.g., material densities, porosities, thicknesses, alternative materials, etc.) may be combined or used in place of materials described in other embodiments except where explicitly contraindicated.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present disclosure. Accordingly, the above description should not be taken as limiting the scope of the present disclosure or claims.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

1. A modular aquaponics assembly, comprising:
an aquaculture module for growing fish, the aquaculture module comprising an aquaculture tank, an tank inlet, and a tank outlet;
a hydroponics module for growing crops, the hydroponics module comprising a growing bed, a substrate for supporting crops in the growing bed, a bed inlet for admitting water and a bed outlet for exhausting water;
a recirculation assembly comprising a pump fluidly connected with the growing bed and the aquaculture tank for circulating water between the aquaculture module and the hydroponics module, wherein the recirculation assembly circulates water from the bed outlet to the tank inlet and from the tank outlet to the bed inlet; and
a filtration element connected with the recirculation assembly downstream of the hydroponics module and operable to remove debris and excess plant nutrients from a plant wastewater stream exiting the hydroponics module.

2. The assembly of claim 1, wherein the filtration element comprises a filter media operable to remove one or more of excess nitrates, nitrites, soil or particulates from the plant wastewater stream, and to adjust a pH of the plant wastewater stream toward neutral.

3. The assembly of claim 1, wherein the filtration element comprises a filter media comprising one or more of one or more of a porous activated carbon, biochar, lava rock, sand, gravel, perlite, clay pebbles, or woven or nonwoven textile filters.

4. The assembly of claim 1, wherein the hydroponics module and aquaculture module comprise a stacked assembly comprising:
a first portion containing the growing bed positioned above a second portion containing the aquaculture tank; and
a divider separating the first portion from the second portion and containing the filtration element.

5. The assembly of claim 1, wherein the substrate comprises a support structure for suspending crops in the growing bed above a supply of water.

6. The assembly of claim 1, wherein the substrate comprises soil.

7. The assembly of claim 1, wherein the growing bed of the hydroponics module comprises a sloped trough, the bed inlet being positioned at an upper extent of the sloped trough and the bed outlet being positioned at a lower extent of the sloped trough.

8. The assembly of claim 1, further comprising:
an environmental source of water;
a heat exchange element configured to draw a flow of water from the environmental source of water; and
a heat exchanger comprising a heat exchange pipe positioned in the heat exchange element and fluidly connected with the aquaculture tank for exchanging head between the heat exchange element and the aquaculture tank.

9. The assembly of claim 1, further comprising a greenhouse enclosure containing the hydroponics module.

10. The assembly of claim 9, wherein the greenhouse enclosure contains Lepidoptera.

11. The assembly of claim 9, further comprising:
an apiculture module comprising an apiculture enclosure enclosing a hive; and
a duct connecting the apiculture module with the greenhouse enclosure for allowing bees to transit between the hive and hydroponics module.

12. The assembly of claim 1, wherein at least one of the aquaculture module or hydroponics module is contained in an ISO shipping container.

13. A method of farming, comprising:
in an aquaponics system comprising:
an aquaculture module comprising a tank for growing fish; and
a hydroponics module comprising a bed for growing crops;
circulating a flow of aquaculture wastewater exiting from the tank of the aquaculture module to the hydroponics module;
passing the flow of aquaculture wastewater through the crops in the bed of the hydroponics module;
filtering debris and excess plant nutrients from a flow of plant wastewater exiting from the bed of the hydroponics module to create a filtered flow of plant wastewater; and
circulating the filtered flow of plant wastewater to the aquaculture module.

14. The method of claim 13, wherein filtering the debris and excess plant nutrients from the flow of plant wastewater comprises removing one or more of excess nitrates, nitrites, soil, or particulates from the flow of plant wastewater by passing the flow of plant wastewater through a filter media selected from one or more of a porous activated carbon, biochar, lava rock, sand, gravel, perlite, clay pebbles, or woven or nonwoven textile filters.

15. The method of claim 13, further comprising:
detecting a water temperature in the tank; and
exchanging heat between water in the aquaculture module and a reservoir of warmer or cooler water in a heat exchange module when the water temperature is outside a predefined range of temperatures.

16. A modular aquaponics system, comprising:
an aquaculture module for growing fish, the aquaculture module comprising an aquaculture tank, an tank inlet, and a tank outlet;
a hydroponics module for growing crops, the hydroponics module comprising a growing bed, a substrate for supporting crops in the growing bed, a bed inlet for admitting water and a bed outlet for exhausting water;
a recirculation assembly comprising a first pump fluidly connected with the growing bed and the aquaculture tank for circulating water between the aquaculture module and the hydroponics module, wherein the recirculation assembly circulates water from the bed outlet to the tank inlet and from the tank outlet to the bed inlet;
a heat exchange element containing a flow of water at a different temperature than the water contained in the aquaculture module; and
a heat exchanger comprising a second pump and heat exchange tubing positioned in the heat exchange element and fluidly connected with the aquaculture tank of the aquaculture module such that, when the second pump is activated, the heat exchanger transfers heat between the water contained in the aquaculture module and the heat exchange element.

17. The system of claim 16, further comprising:
a sensor positioned in the aquaculture module for detecting a temperature of water in the aquaculture module; and
a controller comprising one or more processors and memory containing nontransitory instructions that, when executed by the one or more processors, cause the controller to:
determine whether the temperature of water in the aquaculture module is outside of a temperature range; and
activate or deactivate the second pump based on determining that the temperature of water in the aquaculture module is outside of the temperature range.

18. The system of claim 16, wherein the heat exchange element comprises a third pump and an environmental source pipe configured to draw the flow of water from an environmental water source and into the heat exchange element by the third pump.

19. The system of claim 16, wherein the heat exchange element comprises a third pump and a solar heating assembly, wherein the third pump is arranged to circulate the flow of water to the solar heating assembly, and wherein the solar heating assembly comprises a solar heater configured to heat the flow of water.

20. The system of claim 16, further comprising a filtration element connected with the recirculation assembly downstream of the hydroponics module and operable to remove debris and excess plant nutrients from a wastewater stream exiting the hydroponics module.
